(19) United States
(12) Patent Application Publication
(10) Pub. No.: US 2016/0179403 A1
(43) Pub. Date: Jun. 23, 2016

(54) STORAGE CONTROLLER, STORAGE DEVICE, STORAGE SYSTEM, AND SEMICONDUCTOR STORAGE DEVICE

(71) Applicant: HITACHI, LTD., Chiyoda-ku, Tokyo (JP)

(72) Inventors: Kenzo KUROTSUCHI, Tokyo (JP); Seiji MIURA, Tokyo (JP)

(73) Assignee: Hitachi, Ltd., Chiyoda-ku, Tokyo (JP)

(21) Appl. No.: 14/905,232

(22) PCT Filed: Jul. 17, 2013
(86) PCT No.: PCT/JP2013/069452

§ 371 Date: Jan. 14, 2016

(51) Int. Cl. G06F 3/06; G06F 12/02

(52) U.S. Cl. CPC G06F 3/0611; G06F 3/0652; G06F 3/0659; G06F 3/0689; G06F 3/0688; G06F 12/0253; G06F 2212/1044

(57) ABSTRACT

A storage controller controlling a plurality of semiconductor storage devices includes at least one first semiconductor storage device storing effective data, and at least one second semiconductor storage device not storing effective data. The storage controller includes a table for management of information identifying the second semiconductor storage device from the plurality of semiconductor storage devices, and a control unit accessing the first semiconductor storage device or the second semiconductor storage device based on an operation state of the first semiconductor storage device and the table, and dynamically changing the table according to the access.

### TECHNICAL FIELD

The present invention relates to a storage controller controlling a plurality of semiconductor storage device, a storage device including a semiconductor storage device and a storage controller, a storage system connecting a storage device and a server, and a semiconductor storage device including a storage controller controlling a plurality of non-volatile memory chips and the plurality of non-volatile memory chips.

### BACKGROUND ART

Semiconductor storage devices having a writable non-volatile memory such as a flash memory have been widely used for storage devices as a substitute for a hard disk, digital cameras, portable music players, or the like. Although the capacity of the semiconductor storage devices has been increased, further increase of the capacity of the semiconductor storage devices has been demanded due to pixel enlargement in digital cameras, high-quality sound of portable music players, video reproduction, convergence of broadcast and communication, increase of the amount of data handled by storages corresponding to big data, or the like.

In response, improvement of elements of the semiconductor storage devices advances development of technology for improving a storage density. For example, in PTL 1 discloses increase of storage density using a phase-change memory, and a technology using a plurality of semiconductor storage devices collected as one storage device or a technology using a plurality of non-volatile memory chips collected as one semiconductor storage device is developed to respond to the demand for increase of the capacity.

Further, performance is also important generally to storage devices, and performance is also important to the semiconductor storage devices without exception. In a computer using a semiconductor storage device as a storage device, performance of the semiconductor storage device influences performance of information processing of the computer, and in a digital camera using the semiconductor storage device as the storage device, the performance of the semiconductor storage device also influences continuous shooting performance or the like.

The semiconductor storage device needs to perform garbage collection in the semiconductor storage device, as a different characteristic from those of the other storage devices, such as hard disks. For example, PTL 2 discloses performance of housekeeping operations in the foreground in a flash memory system. The housekeeping operations include wear leveling, scrapping, data compaction and pre-emptive garbage collection. PTL 3 discloses performance of garbage collection for a plurality of flash memories as an array configuration. PTL 4 discloses a range to be subjected to a compaction process including garbage collection in a flash memory system, the range being dynamically set based on the number of usable blocks and an amount of effective data in the blocks. NPL 1 discloses garbage collection performed in a flash memory system based on a predetermined policy.

### CITATION LIST

### Patent Literature

PTL 1: International Unexamined Patent Application No. 2011/074545
PTL 2: Japanese Unexamined Patent Application Publication No. 2009-282989
PTL 3: U.S. Unexamined Patent Application Publication No. 2012/0059978
PTL 4: Japanese Unexamined Patent Application Publication No. 2013-030081

### Non Patent Literature

NPL 1: “Write amplification analysis in flash-based solid state drives”, Proceedings of The Israeli Experimental Systems Conference (SYSTOR) (2009), pp. 1-9

### SUMMARY OF INVENTION

### Technical Problem

The storage device using the semiconductor storage device or the like includes, as an important performance index, input/output per second (IOPS) performance, response performance, or the like, and improvement of the performance is demanded. The IOPS performance represents the number of reads and writes for one second. The response performance represents a time required from issuance of a read request or a write request from a server to a storage device to completion of processing according to the request, and a storage device having a short response time is called a storage device having a high response performance. The IOPS performance does not always correspond to the response performance, but for example, a storage device having a short response time can promptly start handling of a next request, and thus, the storage device also has a high IOPS performance.

In such a performance index, when the server issues the read request or the write request during garbage collection of the semiconductor storage device, the semiconductor storage device interrupts a process of the garbage collection to perform processing according to the request, and a response time is extended by a time required for interruption of the process of the garbage collection, and the IOPS performance is degraded. In particular, in the write request, update of memory management in the semiconductor storage device performed by the garbage collection cannot be interrupted before reaching a matching state in which an additional write is allowed, and thus a longer time is required for the interruption compared to that of the read request. Further, even during a time other than the garbage collection, when a plurality of read requests or write requests are issued from the server to one semiconductor storage device, the response time is extended by a time required for completion of processing according to the other request(s), and the IOPS performance is degraded.

A technology relating to performance during the garbage collection and a technology relating to performance in the plurality of requests are not disclosed in PTLS 1 to 4 and NPL 1, against such degradation of performance.

Therefore, a first object of the present invention is to prevent or reduce degradation of IOPS performance or response performance due to performance of garbage collection performed by a semiconductor storage device. A second object of the present invention is to further improve IOPS performance or response performance even during a time other than garbage collection.

### Solution to Problem

A storage controller according to the present invention controls a plurality of semiconductor storage devices including at least one first semiconductor storage device storing effective data and at least one second semiconductor storage device not storing effective data, and the storage controller includes a table for management of information identifying the second semiconductor storage device from the plurality of semiconductor storage devices, and a control unit accessing the first semiconductor storage device or the second semiconductor storage device based on an operation state of the first semiconductor storage device and the table, and dynamically changing the table according to the access.

Further, the second semiconductor storage device is used for storing new effective data in the second semiconductor storage device or at least two first semiconductor storage devices other than the first semiconductor storage device, an operation state of the first semiconductor storage device includes an operation state based on a garbage collection instruction to the semiconductor storage device and garbage collection completion notice from the semiconductor storage device, and the storage controller includes the control unit accessing the first semiconductor storage device or the second semiconductor storage device based on an operation state of garbage collection of the first semiconductor storage device and the table.

Further, the storage controller includes the control unit accessing the first semiconductor storage device or the second semiconductor storage device based on an operation state of concentrated accesses to the first semiconductor storage device.

The storage controller includes the control unit changing access to the first semiconductor storage device having the operation state of garbage collection or the operation state of concentrated accesses, to access to the first semiconductor storage device other than the first semiconductor storage device as an access destination or the second semiconductor storage device, and accessing the first semiconductor storage device or the second semiconductor storage device to which the access destination is changed.

Further, the present invention can be grasped as a storage device including the storage controller, a storage system, and a semiconductor storage device including the storage controller controlling a non-volatile memory chip instead of the semiconductor storage device.

### Advantageous Effects of Invention

According to the present invention, high IOPS performance or high response performance can be maintained, and moreover, higher IOPS performance or higher response performance can be provided.

### BRIEF DESCRIPTION OF DRAWINGS

FIG. 1 is a diagram illustrating an exemplary configuration of a server-storage system.

FIG. 2 is a diagram illustrating an example of a basic SSD (or semiconductor storage device) alternative table.

FIG. 3 is a diagram illustrating an exemplary correspondence relationship between addresses.

FIGS. 4(a) and 4(b) are diagrams illustrating exemplary correspondence relationships between addresses and SSD numbers before and after a write.

FIG. 5 is a table illustrating an example of SSD management information.

FIG. 6 is a diagram illustrating an exemplary operation of a storage system.

FIG. 7 is an exemplary flowchart illustrating a garbage collection process.

FIG. 8 is an exemplary flowchart illustrating a write process in a storage system.

FIG. 9 is an exemplary flowchart illustrating a write process performed by a storage controller (STC).

FIG. 10 is an exemplary flowchart illustrating a read process in a storage system.

FIG. 11 is a diagram illustrating an example of an SSD alternative table according to a second embodiment.

FIG. 12 is an exemplary flowchart illustrating a write process performed by an STC according to the second embodiment.

FIG. 13 is a diagram illustrating an exemplary configuration of a storage device according to a third embodiment.

FIG. 14 is an exemplary flowchart illustrating an SSD number determination process according to the third embodiment.

FIG. 15 is a diagram illustrating an exemplary correspondence relationship between addresses and SSD numbers according to the third embodiment.

FIGS. 16(a) and 16(b) are diagrams illustrating exemplary correspondence relationships between addresses and SSD numbers before and after a write according to the third embodiment.

FIG. 17 is a diagram illustrating an example of an SSD alternative table according to a fourth embodiment.

FIGS. 18(a) and 18 (b) are diagrams illustrating exemplary correspondence relationships between addresses and SSD numbers before and after a write according to the fourth embodiment.

FIG. 19 is a diagram illustrating an example of an SSD alternative table according to a fifth embodiment.

FIGS. 20(a) and 20 (b) are diagrams illustrating exemplary correspondence relationships between addresses and SSD numbers before and after a write according to the fifth embodiment.

FIG. 21 is an exemplary flowchart illustrating a read process in a storage system according to a sixth embodiment.

FIG. 22 is an exemplary flowchart illustrating a write process performed by an STC according to a seventh embodiment.

FIG. 23 is a diagram illustrating an exemplary correspondence relationship between addresses and SSD numbers according to an eighth embodiment.

FIG. 24 is a diagram illustrating an exemplary configuration of an SSD according to a ninth embodiment.

FIG. 25 is a diagram illustrating an exemplary correspondence relationship between addresses and SSD numbers according to a tenth embodiment.

FIG. 26 is a diagram illustrating an exemplary correspondence relationship between addresses and SSD numbers according to an eleventh embodiment.

### DESCRIPTION OF EMBODIMENTS

Embodiments of a storage controller, a storage device, a storage system, and a semiconductor storage device will be described in detail below with reference to accompanying drawings.

### First Embodiment

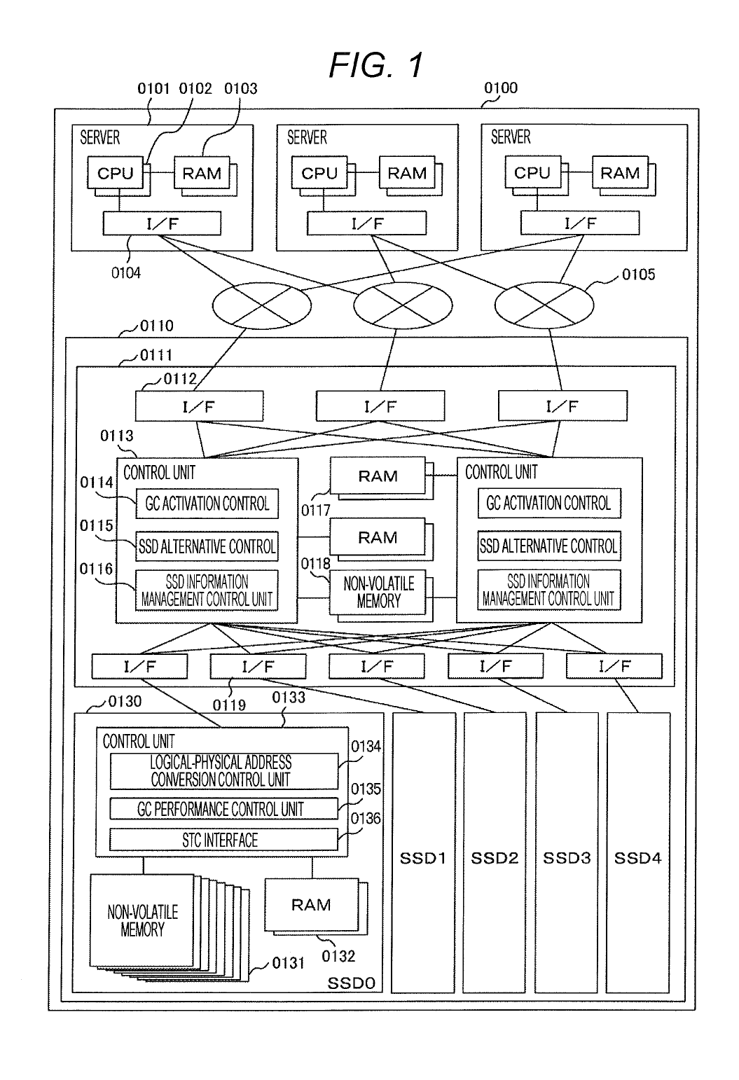

FIG. 1 illustrates an exemplary configuration of a server-storage system 0100 in which a plurality of servers 0101 and the storage device 0110 are connected to each other.

Each of the servers 0101 is a general computer, and includes a CPU 0102, a RAM 0103, and a storage interface 0104. The server 0101 is connected to the storage device 011D through a switch 0105 or the like.

The storage device 0110 includes the storage controller (hereinafter, referred to as STC) 0111 and at least two semiconductor storage devices (hereinafter, referred to as solid state drive, SSD) 0130. The storage system 0110 can have a plurality of STCs 0111. Note that the storage device 0110 can have a hard disk in addition to the SSDs 0130. Further, each of the SSDs 0130 is not only included in the storage device 0110, but also connected to the storage device 0110 as an external SSD. The STC 0111 has a random access memory (RAM) 0117. As the RAM 0117, a dynamic random access memory (DRAM) can be also used. The RAM 0117 stores data cache, alternative SSD table information, SSD management information, which are described later. Further, the STC 0111 can have a non-volatile memory 0118. The non-volatile memory 0118 is used to retract the contents of the RAM 0117 upon power failure, or used to hold storage configuration information. The storage configuration information represents configuration information for example, redundant arrays of inexpensive disks (RAID) or just a bunch of disks (JBOD). The STC 0111 may have a battery for retraction of data upon power failure.

In the STC 0111, a control unit 0113 has a GC activation control 0114, an SSD alternative control 0115, and an SSD management information control 0116. The GC activation control 0114 is a control unit selecting an SSD 0130 based on the number of erased blocks of the SSDs 0130, and information about an SSD 0130 in which garbage collection is performed, and instructing the SSD 0130 to increase the number of erased blocks to or above a certain number. Note that this instruction is referred to as “GC activation”, and operation of the SSD 0130 increasing the number of erased blocks is referred to as “under GC”. The SSD alternative control 0115 is a control unit performing alternative write process of selecting an SSD 0130 as a write destination to write data to be written not to the SSD 0130 under GC but to another SSD 0130 upon generation of a write request from the server 0101 to the storage device 0110, and selecting an SSD 0130 to read data from an SSD 0130 storing the written data with reference to information in the alternative write process, upon generation of a read request from the server 0101 to the storage device 0110. The SSD management information control 0116 manages the number of erased blocks reported from the SSDs 0130, and the number of the SSD 0130 in which garbage collection is performed. In the STC 0111, a server interface 0112 and an SSD interface 0119 each include an interface to the server 0101 and an interface to the SSD 0130.

The SSD 0130 includes a non-volatile memory 0131, a RAM 0132, and a control unit 0133. The non-volatile memory 0131 may be, for example, a NAND flash memory of a multi-level cell (MLC) type or a single-level cell (SLC) type, a phase-change memory, or a ReRAM, and the non-volatile memory 0131 stores write data from the server 0101. The RAM 0132 may be, for example, a DRAM, a MRAM, a phase-change memory, or a ReRAM, and the RAM 0132 is used to store all or part of data buffer, a data cache, an SSD logical address-physical address conversion table used for conversion in the SSD, effective/ineffective information for each page, and block information such as a state of erased/defective block/programmed block or the number of erasures. Further, in order to inhibit information loss in the RAM 0132 due to power failure or the like, the control unit 0133 may retract the contents of the RAM 0132 to the non-volatile memory 0131 upon power failure. Further, the SSD 0130 may have a battery or a super capacitor to reduce the probability of the data loss upon power failure. The control unit 0133 has a logical-physical address conversion control unit 0134, a GC performance control unit 0135, and an STC interface 0136. The logical-physical address conversion control unit 0134 performs conversion between an SSD logical address used for access of the STC 0111 to the SSD 0130 and a physical address used for access of the control unit 0133 to the non-volatile memory 0131. In this conversion, the control unit 0133 performs wear leveling for leveling writing to the non-volatile memory 0131. The GC performance control unit 0135 is a portion performing the garbage collection described later to form erased blocks having the number not less than the number of blocks specified by the STC 0111. The STC interface 0136 includes an interface with the STC 0111. The control unit 0133 can also have a non-volatile memory interface or a RAM interface, which are not illustrated.

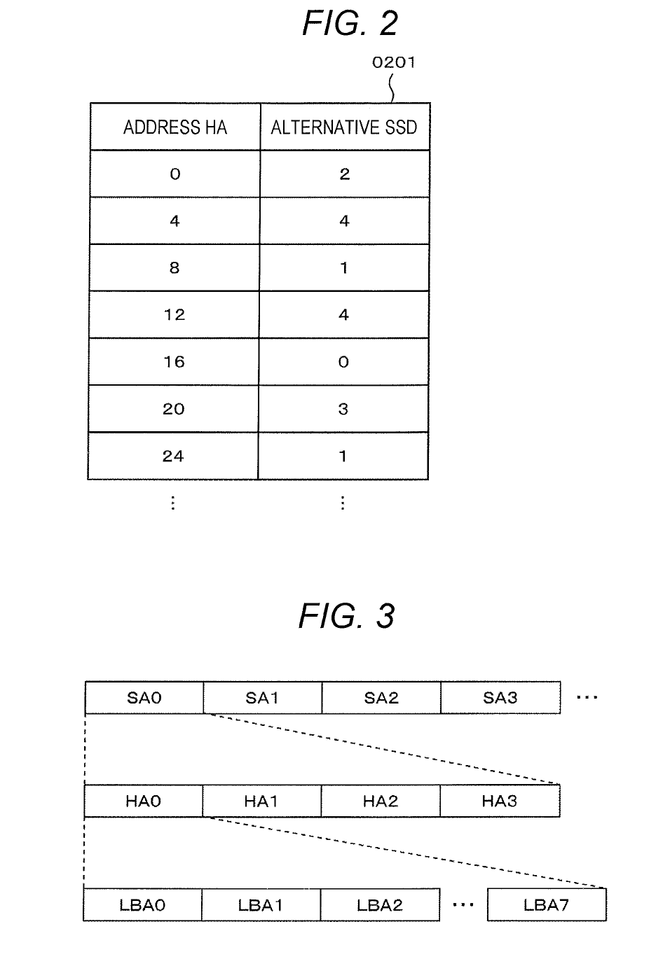

FIG. 2 illustrates an example of an SSD alternative table 0201 stored in the RAM 0117 of the STC 0111. The SSD alternative table 0201 is used for the SSD alternative control 0115. The SSD alternative table 0201 stores alternative SSD numbers S (wherein S is 0 to 4) corresponding to host addresses (hereinafter, referred to as addresses HA), that is, the alternative SSD numbers S being in the same stripe in which the addresses HA are stored. In FIG. 2, for example, an alternative SSD number S is 2 for a stripe of the addresses HA0 to HA3, and an alternative SSD number S is 4 for the stripes of the addresses HA4 to HA7. The stripe is a unit for management of the alternative SSDs by the SSD alternative control 0115, and the alternative SSD numbers are managed for each stripe. Only management of the alternative SSD number for each stripe can reduce a size of data of an alternative SSD table 0201. Therefore, in the STC 0111, the RAM 0117 can have a small capacity, and the storage device 0110 can be achieved inexpensively.

The address HA will be described using FIG. 3. In the server 0101, software often manages data having a size larger than a data unit which can be specified by a host interface 0112 of the storage device 0110. Thus, data of one address HA is preferably has a size substantially equal to a size of data used for access of the server 0101 to the STC 0111. Description will be made below of an example of the data of the address HA, having a size of 4 KB. Further, for signals of the host interface 112 of the storage device 0110, the server 0101 uses logical block addressing (LBA) to specify an address for access. The size of data of one LBA is for example 512 B. Note that it is obvious that the server 0101 can use 4K-native or the like for 4 KB addressing to access the STC 0111. When the size of data of the address HA is 4 KB and the size of data of an address LBA is 512 B, mutual conversion between the address LBA and the address HA can be performed based on the following formula (1).

Address LBA=address HA×8 (1)

The storage controller 111 manages data in stripes of data, the stripes having a plurality of collected addresses HA. When the number of alternative SSDs is S_{CNT} and the number of all SSDs is N_{CNT}, mutual conversion between a stripe address (hereinafter, referred to as address SA) and the address HA can be performed using the following formula (2). The stripe address represents an address of a stripe of data.

Address HA=address SA×(N_{CNT}−S_{CNT}) (2)

Description will be made below of an example in which an SSD capacity is 10 TB, the number of SSDs N_{CNT} is 5, and the number of alternative SSDs S_{CNT} is 1. The following formula (3) can be obtained from formula (2).

Address HA=address SA×4 (3)

An exemplary correspondence relationship, in this example, between the addresses SA, the addresses HA, and the addresses LBA is illustrated in FIG. 3. For example, a size of data managed by one address HA is 4 KB, and a size of data managed by one address SA is 16 KB.

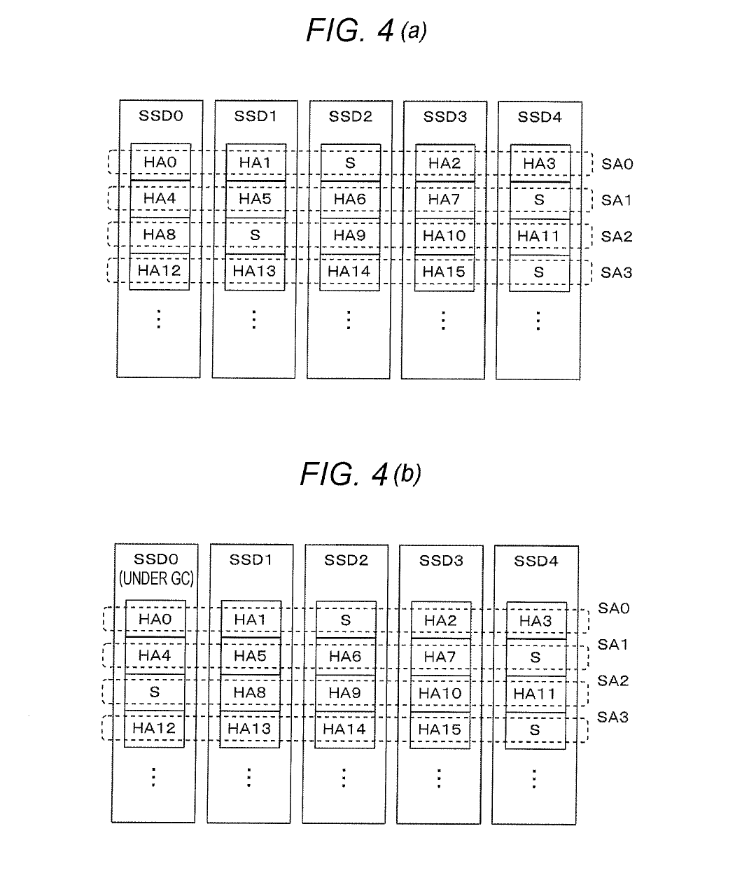

FIG. 4(a) illustrates relationships between the addresses HA and the SSDs storing data corresponding to the addresses. One set of stripe data stores data corresponding to four addresses HA, and includes one alternative SSD denoted by “S” in FIG. 4(a). The alternative SSD is an SSD 0130 not storing effective data in a stripe unit, and is used for writing, instead of writing to an SSD 0130 under GC, to another SSD 0130. Further, writing to the SSD 0130 under GC is not performed, so that the SSD 0130 under GC is defined as a next alternative SSD. The alternative SSD does not function as an SSD but functions for an address HA in one stripe. For example, one address SA0 stores effective data for SSD numbers 0, 1, 3, and 4 corresponding to addresses HA0, HA1, HA2, and HA3, and SSD number 2 in the address SA0 is the alternative SSD and does not store the effective data.

As illustrated in FIG. 4(a), in one stripe, the addresses HA are always arranged to the SSD numbers in ascending order. For example, in the address SA0, the addresses HA0, HA1, HA2, and HA3 are arranged in this order from the left side in FIG. 4(a). As described above, when the addresses HA are arranged in one stripe in the ascending order, the addresses HA match the SSD numbers on the left side from S. On the right side from S, when the number of alternative SSDs are added to the addresses HA, that is, when one stripe has one alternative SSD, and where information of one alternative SSD is held per one stripe, as shown in the SSD alternative table 0201 of FIG. 2, an SSD number can be calculated, indicating which SSD stores data corresponding to an address HA.

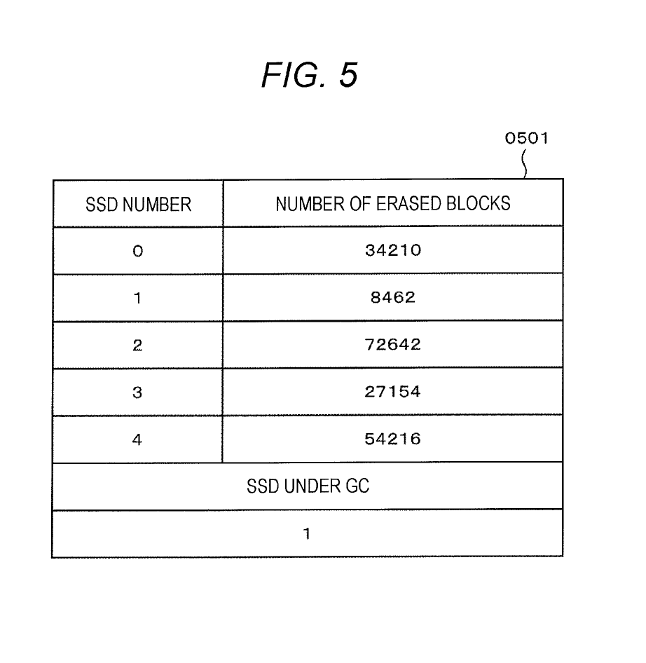

FIG. 5 illustrates an example of SSD management information 0501. The SSD management information 0501 holds the number of erased blocks in each SSD 0130 and a number of SSD under GC. The STC 0111 can determine an SSD to which a next garbage collection instruction is given or can recognize an SSD under GC, based on the SSD management information 0501.

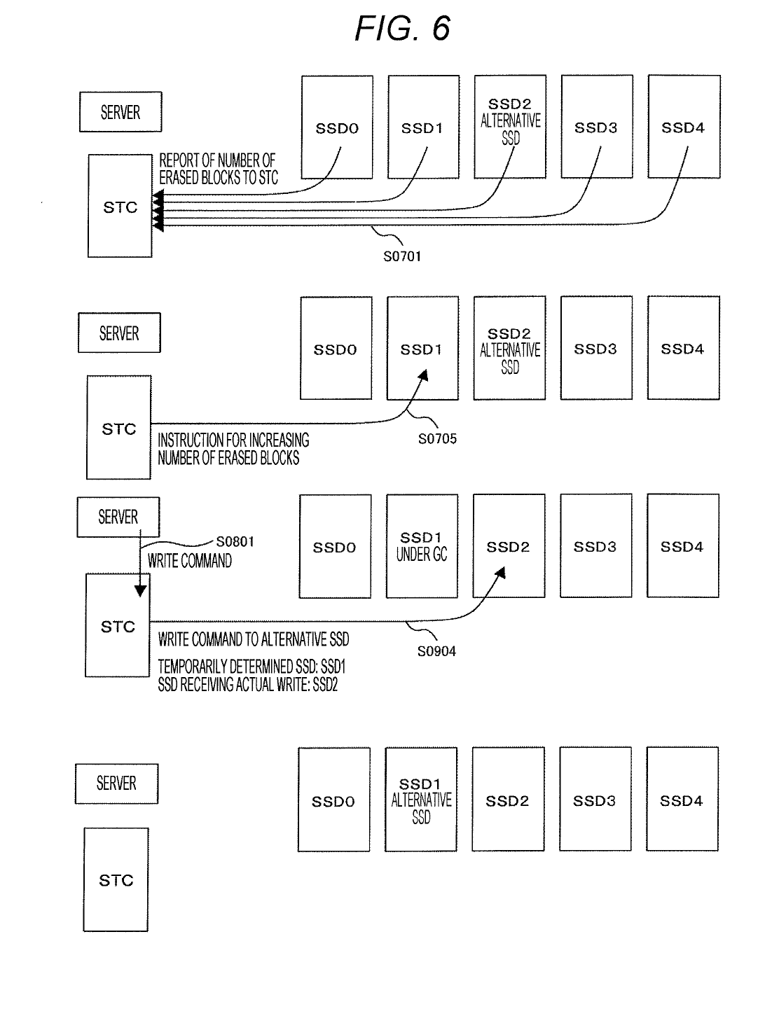

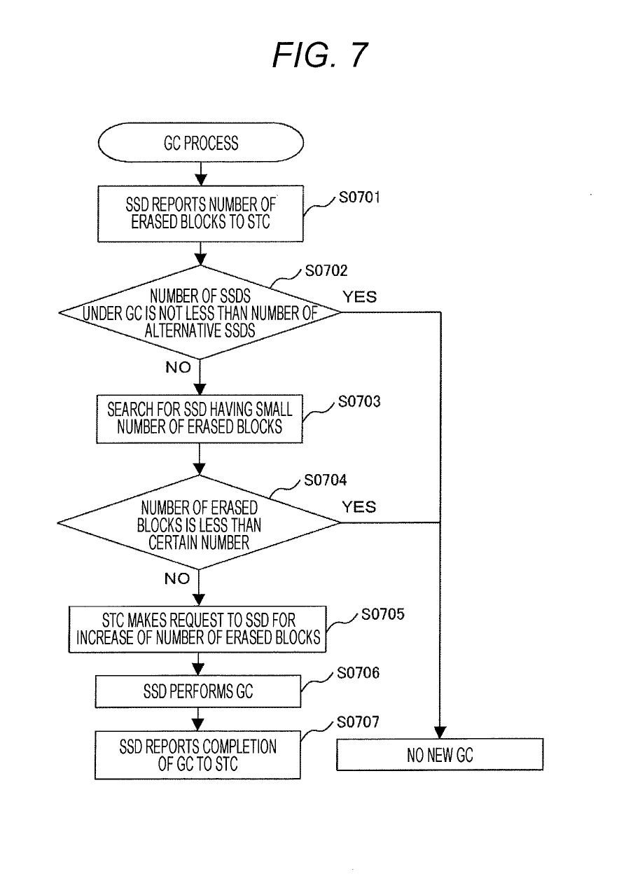

A method of increasing the number of erased blocks in the SSD 0130 will be described using FIGS. 6 and 7. FIG. 6 is a diagram illustrating information transmitted and received between the server 0101, the STC 0111, and the SSDs 0130. Further, FIG. 7 is an exemplary flowchart illustrating a procedure of garbage collection. The SSD 0130 reports the number of erased blocks to the STC 0111 (step S0701). The STC 0111 stores the number of erased blocks in the SSD management information 0501, using the SSD management information control 0116. Next, the STC 0111 uses the GC activation control 0114 to determine whether to perform garbage collection on the SSD 0130 (steps S0702 to S0704). This determination can be made as follows. The STC 0111 refers to the SSD management information 0501, and obtains the number of SSDs in which garbage collection is currently performed. When the number of SSDs in which garbage collection is currently performed is not less than the number of alternative SSDs, additional garbage collection is not performed. When the number of SSDs currently performing garbage collection is less than the number of alternative SSDs, the process proceeds to the next step (step S0702). As described above, the number of SSDs in which garbage collection is simultaneously performed is controlled to be not more than the number of alternative SSDs.

In step S0702, when proceeding to next step S0703 is determined, the SSD management information control 0116 is used to make reference to the SSD management information 0501, searching for the presence of the SSD 0130 in terms of whether the SSD 0130 has the number of erased blocks not more than a block count threshold. As a result of searching, when an SSD 0130 having the number of erased blocks not more than the block count threshold is found, next step S0705 is performed. The block count threshold can be set from a terminal, not illustrated, for managing the STC 0111. The block count threshold is stored in the non-volatile memory 0118 or the like of the STC 0111 to be read upon activation of the STC 111. Further, the block count threshold can be also changed under a certain condition. For example, at night when access to the storage device 0110 is reduced, the block count threshold can be increased to secure a large number of erased blocks. Alternatively, the static of a frequency of access to the storage device 0110 can be taken to increase the block count threshold in a period of time having reduced access, and to reduce the block count threshold in a period of time having increased access. As described above, total optimization is performed on the server-storage system 0100 to have high performance.

In step S0705, the STC 0111 gives an instruction to the SSD 0130 to increase the number of erased blocks up to a target number of blocks (GC activation). The target number of blocks can have a value, for example, obtained by adding a certain number of blocks, 5% of total number of blocks of the non-volatile memory 0131 in the SSD 0130 to a block count threshold. Alternatively, for the server-storage system 0100 having accesses to the storage device 0110 different between day time and night time, statistics of accesses to data from the server 0101 is collected in the storage device 0110, then, a value is obtained by adding the number of margin blocks to an estimated value of the number of erased blocks required for handling accesses in the day time, and the value can be used as the target number of blocks. The number of margin blocks is for example 50% of the estimate value.

Next, the SSD 0130 performs garbage collection to increase the number of erased blocks (step S0706). In the garbage collection, the GC performance control unit 0135 in the SSD 0130 performs a read, a write, and erasure of the non-volatile memory 0131, and increases the number of erased blocks of the non-volatile memory 0131. The garbage collection updates a correspondence relationship between a physical address being an address used for access of the control unit 0133 to the non-volatile memory 0131, and a logical address being an address used for access of the STC 0111 to the SSD 0130. The logical-physical address conversion control unit 0134 manages the correspondence relationship using a logical-physical address conversion table. The logical-physical address conversion table can be stored in the non-volatile memory 0131. Further, the logical-physical address conversion table or part thereof can be stored in the RAM 0132.

More specifically, a process of the garbage collection will be described. The GC performance control unit 0135 searches for a block including a large amount of ineffective data (also referred to as invalid data) unlikely to be read from the STC 0111 in the future, for example based on block management information of the non-volatile memory 0131 stored in the RAM 0132, and copies, to another block, effective data (also referred to valid data) included in the block and likely to be read from the STC 111 in the future. Note that the block represents a unit of the non-volatile memory 0131 erased by the control unit 0133. Then, the block as a copy source is erased. Performance of the garbage collection can increase the number of erased blocks.

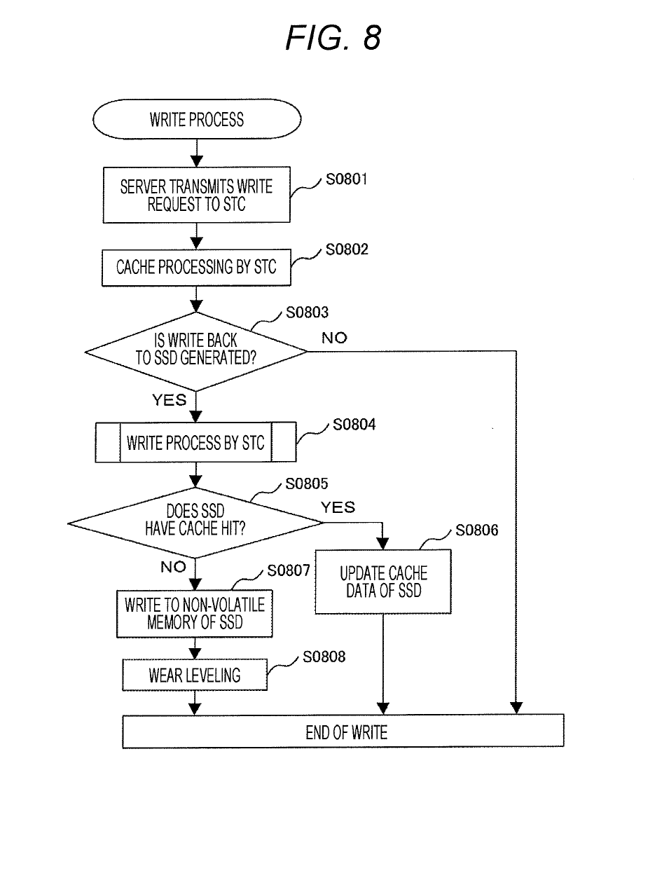

Next, write process in the server-storage system 0100 will be described using FIGS. 6 and 8. The write process is started when the server 0101 transmits a write request to the storage device 0110 (step S0801). The server 0101 can put a write command and write data together, and transmit them to the storage device 0110. Specifically, the CPU 0102 can transmit the write data held in the RAM 0103 in the server 0101 to the storage device 110 through the storage interface 0104.

Further, the CPU 0102 can also transmit a plurality of write data sets, after transmitting a plurality of write commands, according to a plurality of write requests. Note that the server 0101 can query the storage device 0110 for the number of erased blocks for each SSD 0130. Further, the STC 0111 can report the number of erased blocks reaching a certain value to the server 0101. The server 0101 can change accesses to the storage device 0110, based on a result of the query or a result of the report from the STC 0111. Thus, a certain level of response performance of the storage device 0110 can be maintained, and high-response server-storage system 0100 can be achieved.

Next, cache hit determination is performed in the STC 0111 (step S0802). As a cache configuration, a write-back cache, a set associative cache, or the like can be used. Based on an address HA determined from an address LBA included in a write request, a cache entry number and a tag value are determined, cache information of the corresponding cache entry number is checked, and whether the tag values match is checked for all lines belonging to the entry. When data written to the storage device 0110 from the server 0101 is in a cache of the STC 0111 (cache hit), the data in the cache is updated. At this time, a write to the SSD 0130 is not performed. When cache data is updated, the corresponding line is marked as dirty (data in the SSD is different from data in the cache). Note that when the data in the SSD and the data in the cache match, the cache is clean. Cache management information manages whether line is dirty or clean. When the line marked dirty is discarded, data in the cache is written back to the SSD 0130. When the write from the server 0101 generates replacement of cache data, line may be discarded. The number of dirty lines in the cache is controlled by the control unit 0113 to be not more than a dirty line count threshold. The dirty line count threshold can be changed by the control unit 0113, based on the number of erased blocks included in the SSD management information 0501. In this configuration, write timing from the STC 0111 to the SSD 0130 can be changed according to the condition of the SSD 0130, response from the STC 0111 to the SSD 0130 can be increased, and the storage system having high performance can be achieved. The cache management information and the cache data can be stored in the RAM 0117 or the non-volatile memory 0118 in the STC 0111.

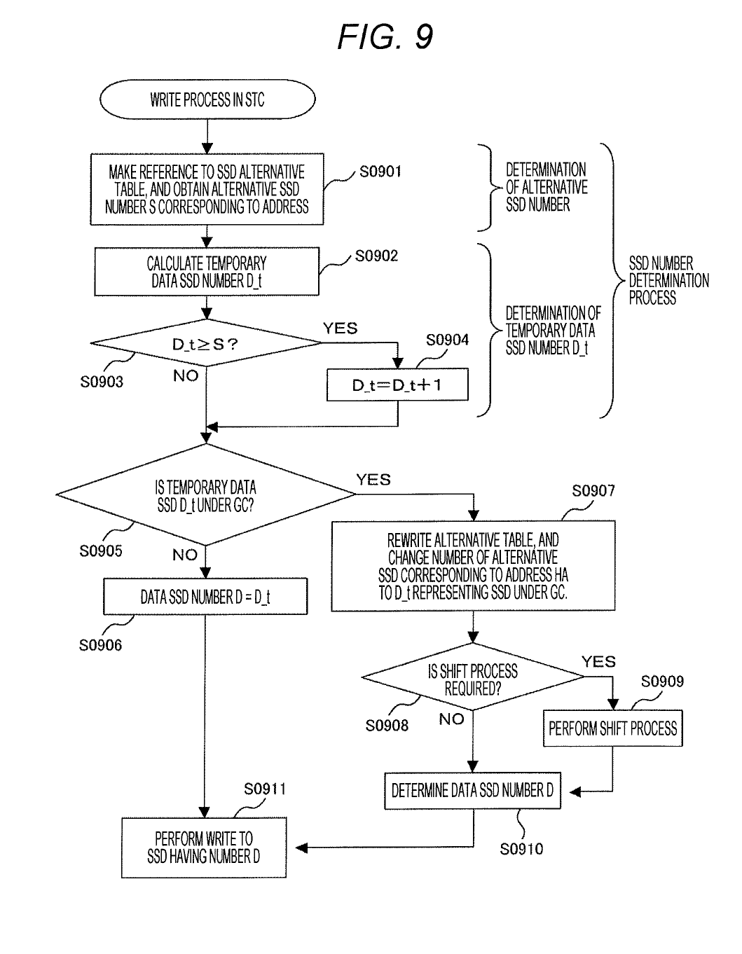

As a result of processing the cache in the STC 0111, it is determined whether to perform a write back to the SSD 0130 (step S0803). When the write back of the cache data to the SSD 0130 is generated, write process is performed by the STC 0111 (step S0804). Detailed description will be made using FIG. 9 illustrating a flowchart of write process performed by the STC 0111. Although the write process using one alternative SSD, that is, one S is described in FIG. 9, a write process using at least two alternative SSDs is similarly configured.

In a write to the SSD 0130 by the SSD alternative control 0115, the alternative write process performed on the SSD 0130 is recorded in the SSD alternative table 0201, and in read from the SSD 0130, a read operation is performed according to alternation between the SSDs 0130. First, the write will be described. The SSD alternative control unit 0115 refers to the SSD alternative table 0201 of FIGS. 4(a) and 4(b), and obtains an alternative SSD number S being in the same stripe in which the addresses HA are stored (step S0901). Next, the following formula (4) is used to calculate a temporary data SSD number D_t from the addresses HA (step S0902).

D_t=address HA mod(N_{CNT}−S_{CNT}) (4)

Wherein, mod represents obtaining a remainder of division. That is, D_t is a remainder obtained by division of the addresses HA by (N_{CNT}−S_{CNT}). Wherein, N_{CNT}=5 and S_{CNT}=1, and the following formula (5) is derived.

D_t=address HA mod 4 (5)

Next, D_t and S are compared (step S0903). When D_t is not less than S, the SSD number is shifted by one S, so that 1 is added to D_t, defining a new temporary data SSD number D_t (step S0904). The addresses HA are arranged in ascending order, and D_t can be obtained by such a simple calculation. Thus obtained temporary data SSD number D_t indicates an SSD 0130, and it is determined whether the SSD 0130 is under a process of increasing the erased blocks (under GC) based on the SSD management information 0501 (step S0905). When the SSD 0130 is not under GC, an actual data SSD number D to which data is actually written is set to D_t (step S0906).

When the SSD 0130 is under GC, data to be written to the SSD 0130 under GC is written to another SSD 0130 (alternative write process). Further, in order to perform correct read based on a read operation from the server 0101 in the future, the alternative write process is recorded. Specifically, the alternative SSD corresponding to the addresses HA in the SSD alternative table 0201 is updated from S to D_t (step S0907). As described above, performance of the alteration to the SSD number D_t is managed in stripes. Next, it is determined whether a shift process is required (step S0908). The shift process is a process for holding the addresses HA in ascending order with respect to the SSD numbers, in the stripe. Specifically, the STC 0111 reads data from an SSD 0130, writes the data to another SSD 0130, copies the data, and rearranges the addresses HA to maintain the ascending order (step S0909). The actual data SSD number D is determined in consideration of shift process determination and the shift process (step S0910). Finally, data is written to an SSD having the actual data SSD number D (S0911).

The addresses HA are an address for management of a plurality of SSDs 0130 collectively, and thus, for an actual write to the SSD 0130, an address is used for each SSD 0130. The SSD logical address LA being an address for each SSD, used for the write from the STC 0111 to the SSD 0130 can be obtained by the following formula (6).

Address LA=address SA (6)

Note that when the address LA is obtained by formula (6), an SSD logical address is generated which is not accessed by the SSD 130. For example, in an example illustrated in FIG. 4(a), an SSD logical address LA0 of the SSD2 is S, and thus, the STC 0111 does not access to the SSD logical address LA0 of the SSD2, as a write destination from the server 0101. Further, the STC 0111 does not access also to the SSD logical address LA1 of SSD4. In consideration of the above facts, the rate of a provisional area of the SSD can be set lower than a normal condition. Specifically, the rate of the provisional area can be set lower than the normal condition by an additional rate PP obtained by the following formula (7). In this condition, conversion from the address HA to the SSD logical address LA can be performed at high speed, and thus achieving the storage device 0110 having a high speed.

PP=(N_{CNT}−S_{CNT})/N_{CNT} (7)

Needless to say, formula (6) can be changed without changing the rate of the provisional area to determine an address LA, eliminating the SSD logical address LA which is not accessed. In this condition, S is not required, and thus, the address conversion table, of the SSD 130, for conversion from the SSD logical address LA to the physical address PA can be reduced in size, the RAM 0132 storing the address conversion table of the SSD 0130 can be reduced in cost, and the storage device 0110 can be achieved inexpensively. An SSD physical address PA is an address used when the control unit 0133 of the SSD accesses the non-volatile memory 0131. The SSD can use the logical-physical address conversion control unit 0134 to convert the SSD logical address LA to the SSD physical address PA.

Further specific description will be made. When the server 0101 updates an address HA8, that is, updates data in LBA64 to LBA71, while SSD0 is under GC, in a state illustrated in FIG. 4(a), a correspondence relationship between the addresses HA and the SSD numbers after the write from the server 0101 is illustrated in FIG. 4(b). The address HA8 corresponds to address SA2. A temporary data number D_t is 0, and a write is attempted to SSD0, but SSD0 is under GC, then, the write to SSD1 being the alternative SSD to the address SA2 is performed. Consequently, data corresponding to the address HA8 is written to an SSD logical address LA2 of SSD1. In this condition, the addresses HA are held in ascending order in the address SA2, and thus, the shift process is not performed. The effective data likely to be referred to by the server 0101 is not written in the SSD logical address LA2 of SSD0. STC 0111 can transmit a Trim command to SSD0 to report that the SSD logical address LA2 has the ineffective data. Performance of the report allows SSD0 to erase an area of the SSD logical address LA2 by the garbage collection, and the garbage collection can be performed more efficiently. Specifically, data to be written and read with respect to the non-volatile memories 0131 can be reduced, the write and read being caused by the garbage collection. Thus, the storage system 110 has improved data transfer performance. Note that the Trim command is a command transmitted from the server 0101 to report an ineffective area to the SSD 0130.

Further, the SSD 130 has a write-back cache to allow writing to the cache of the SSD 0130 when a write request is received from the STC 111. Data pushed out of the cache due to writing of data to the cache is written to the non-volatile memory 0131. Needless to say, the SSD 0130 does not need to have a cache, or the SSD 0130 can have a write cache of a write through cache type, a write to the cache is performed, a write to the non-volatile memory is performed, and then a response is transmitted to the STC 0111 indicating write completion. In this configuration, data reliability is improved against power failure or the like, and the storage device 0110 having high reliability can be achieved.

In a next example, a description will be made of a request from the server 0101 for update only part of a data area indicated by one address HA, for example, update of only addresses LBA0 to LBA3 in the address HA0. The number of SSD under GC is 0. In this condition, STC 0111 reads data in the remaining addresses LBA4 to LBA7 from SSD0 under GC, adds the data in LBA0 to LBA3 transmitted from the server 0101 to the data in the remaining addresses LBA4 to LBA7, and writes the data in the LBA0 to LBA7 (read-modify-write). The SSD 0130 as a write destination controls the SSDs 0130 other than the SSD 0130 under GC. Then, shift process determination is performed (step S0908). In this condition, when data at address HA0 is written to SSD2 being the alternative SSD, the address SA0 is changed to have addresses HA1 (SSD1)-HA0 (SSD2)-HA2 (SSD3)-HA3 (SSD4) therein, and the addresses are not arranged in ascending order with respect to the SSD numbers. Therefore, the shift process is performed (step S0909). Specifically, the STC 0111 reads data at the address HA1 from the SSD1, and then, the STC 0111 writes data at address HA1 to SSD2. In the address SA0, the addresses HA are controlled to be arranged in the ascending order, and a write to SSD0 under GC is not performed. Therefore, the actual data SSD number D of the address HA0 is determined as 1 (step S0910). At last, the data at address HA0 is written to SSD1 (step S0911).

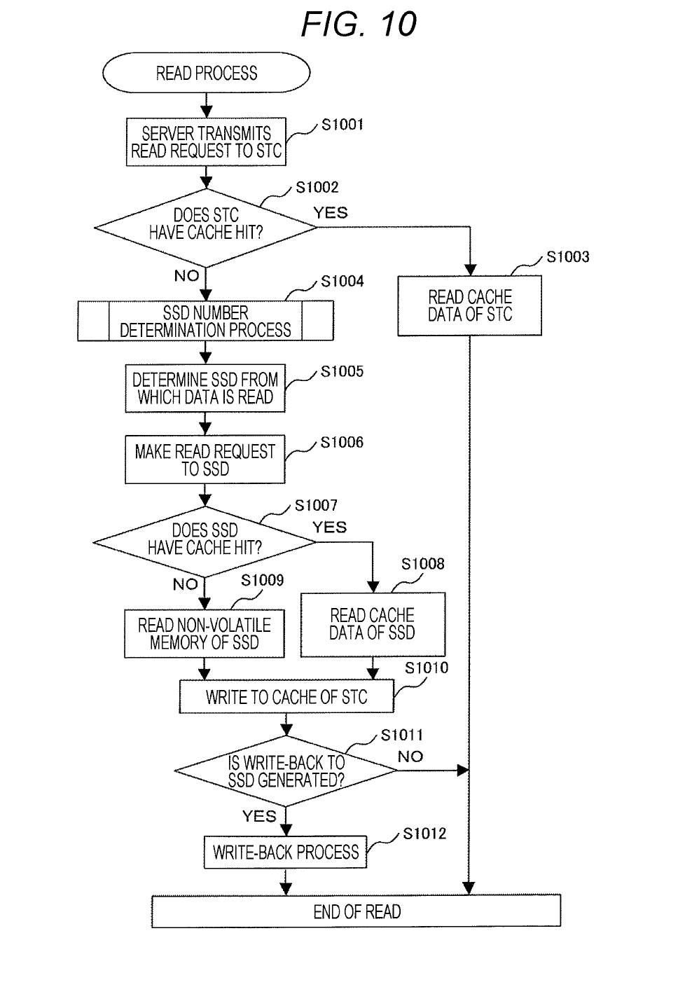

Next, a read process in the server-storage system 0100 will be described using FIG. 10. The read process is started by transmitting a read request to the storage device 0110 by the server 0101 (step S1001). The STC 0111 determines whether a cache hit occurs in the STC 0111, based on an address HA determined based on an address LBA included in a read request (step S1002). Specifically, a cache entry number and a tag value are determined from the address HA, cache information of the corresponding cache entry number is checked, and whether the tag values match is checked for all lines belonging to the entry. When data requested from the server 0101 is in the cache of the STC 0111 (cache hit), the data in the cache is read, and the data is transmitted to the server 0101 (step S1003). When the data requested from the server 0101 is not in the cache of the STC 0111 (cache miss), the data is read from an SSD 0130. Specifically, an SSD number determination process is performed at first (step S1004). The SSD number determination process is a process the same as the determination of the alternative SSD number and the determination of the temporary data SSD number D_t (steps S0901 to S0904). The SSD number for read is D_t (step S1005). Next, the read request is transmitted to the SSDs 0130 (step S1006).

The control unit 0133 determines whether the SSD 0130 has a cache hit (step S10007). When the cache hit occurs, the data is read from the cache (step S1008). When the cache hit does not occur, the data is read from the non-volatile memory 0131, the data is transmitted to the STC 0111, and further the data is written to the cache of the SSD 0130 (step S1009). At that time, when the cache of the SSD 0130 is full, write-back from the cache of the SSD 0130 to the non-volatile memory 0131 may be performed. Next, the STC 0111 transmits the data read from the SSD 0130 to the server 0101, and writes the data in the cache of the STC 0111 (step S1010). Further, when the cache of the STC 0111 is full, whether the write-back from the cache to the SSD 0130 is determined (step S1011). When the write back is generated, data is written to the SSD 0130 (step S1012). Needless to say, at that time, a write to the SSD under GC is controlled and prevented, similar to the write process performed by the STC. The read process is performed according to the flow described above.

According to the process described above, the STC 0111 performs the process of increasing the number of erased blocks, and a write to an SSD 0130 having reduced IOPS performance or reduced response performance is prevented. Therefore, the storage device 0110 having high IOPS performance or high response performance can be achieved. Further, the server 0101 can use the storage device 0110 having high IOPS performance or high response performance, and thus, the server-storage system 0100 having high performance can be achieved, as a whole including the server 0101. In other words, the STC 0111 can conceal the reduction in performance of the SSD which is caused by the garbage collection. Further, reduction in response time of the storage device 110 allows the server 0101 to issue a larger number of commands. Therefore, the IOPS performance of the storage device 0110 can be also improved.

### Second Embodiment

In a second embodiment, the storage device 0110 will be described which has the control unit 0113 controlling the IOPS performance or response performance of the storage device 0110 to be further improved. Specifically, the shift process can be eliminated to reduce the number of reads and writes from the STC 0111 to the SSD 0130.

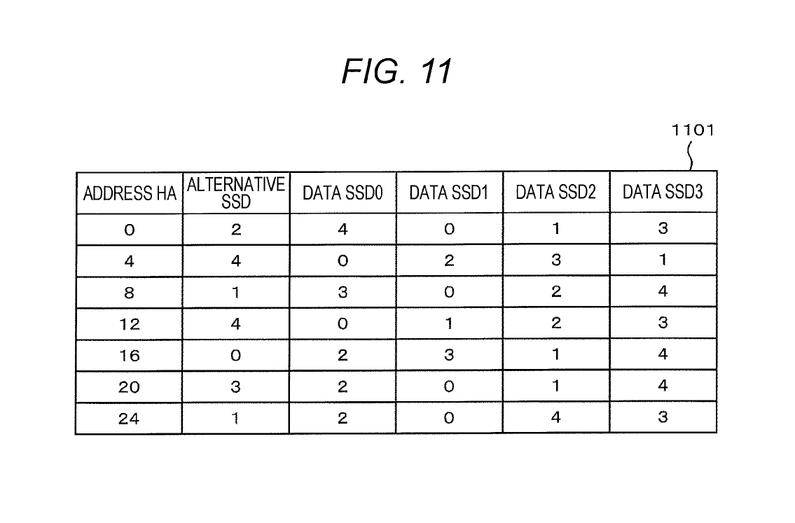

FIG. 11 illustrates an example of an SSD alternative table 1101 eliminating the need for the shift process. In the shift process, both of the addresses HA and the SSD numbers are arranged in the ascending order to calculate the SSD number from the address HA, but the SSD alternative table 1101 also stores the SSD numbers corresponding to the addresses HA, in addition to the SSD number of the alternative SSD, and calculation is not required. In the SSD alternative table 1101, 0 of the addresses HA represents 0 to 3, 4 of the addresses HA represents 4 to 7, data SSD0 represents an address having a remainder of 0 upon dividing the address HA by 9, and data SSD1 represents an address having a remainder of 1 upon dividing the address HA by 4. Therefore, for example, data SSD0 to SSD3 having an address HA of 4 indicate addresses HA4 to HA7, respectively. In a column being on the right side of 4 of the address HA, the alternative SSD has an SSD number of 4, and columns being on the further right side thereof represent that the SSD numbers 0, 2, 3, and 1 correspond to the data SSD0, SSD1, SSD2, and SSD3, that is, the addresses HA4, HA5, HA6, and HA7. The SSD alternative table 1101 can be used to manage the data corresponding to the address HA, indicating which SSD stores the data, calculation is not required to identify the SSD number from the address HA, and the addresses HA do not need to be limited to be arranged in ascending order in the same stripe.

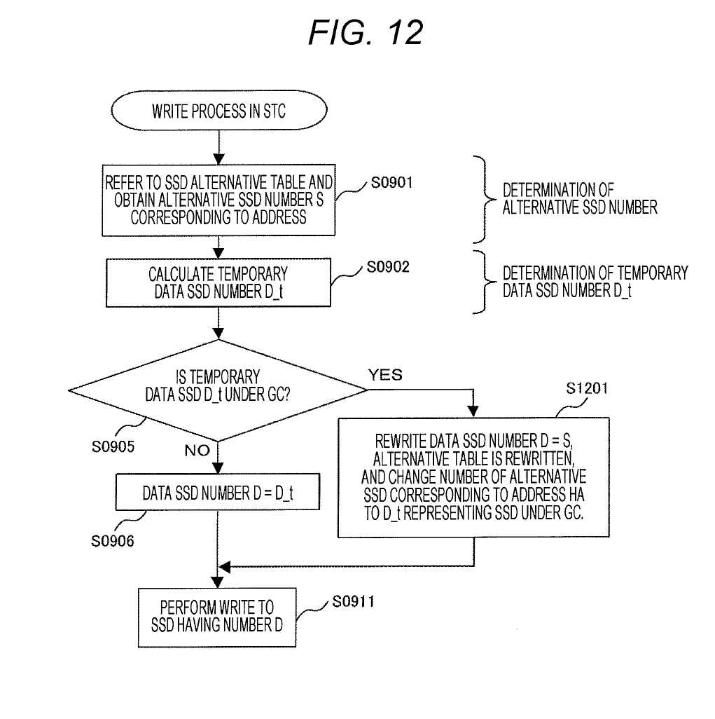

In a flowchart of FIG. 12 illustrating the write process, steps denoted by the same reference signs as those used in FIG. 9 have already been described, and description thereof will be omitted.

In the alternative write process (step S1201), S is set to the actual data SSD number D. After performance of the alternative write process (step S1201), determination of whether the shift process is required (step S908) and performance of the shift process (step S0909) do not need to be performed, and eliminated from the process of FIG. 12.

In the second embodiment, the STC 111 does not need to perform the shift process, the number of reads and writes with respect to the SSD 0130 can be reduced, and thus, the storage device 0110 having high performance can be achieved. Further, the amount of write data to the SSD 0130 can be reduced, and thus, the life of the SSD 0130 can be extended and the storage device 0110 having high reliability can be achieved.

### Third Embodiment

In a third embodiment, description will be made of application of a RAID configuration having high IOPS performance or high response performance, and high reliability.

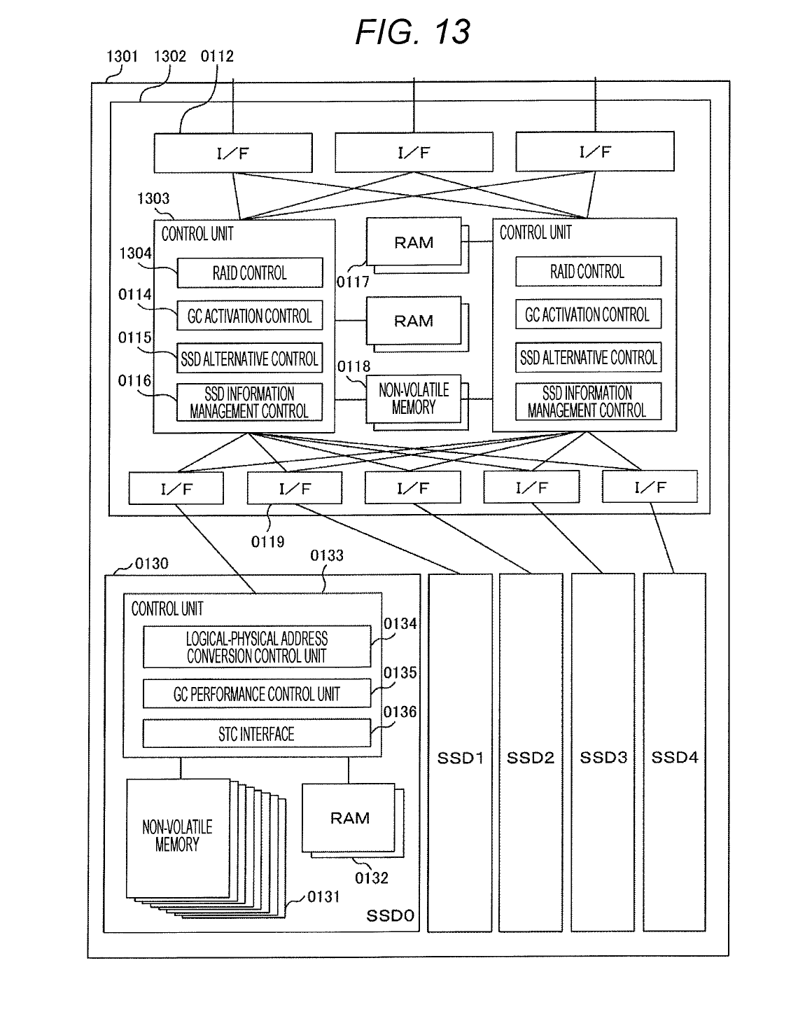

FIG. 13 illustrates a storage device 1301 to which the RAID configuration is further applied.

Configurations denoted by the same reference signs as those used in FIG. 1 have already been described, and description thereof will be omitted.

The storage device 1301 has an STC 1302. The STC 1302 has a control unit 1303. The control unit 1303 has a RAID control unit 1304, the GC activation control unit 0114, the SSD alternative control unit 0115, and the SSD information management control unit 0116. RAID5 will be described as an exemplary configuration of the RAID. The number of all SSDs N_{CNT} is five, and the number of alternative SSDs S_{CNT} is one. In the RAID5, the number of parity SSDs P_{CNT} is one. Note that in a RAID6, the number of parity SSDs P_{CNT} is two. RAID employs a stripe as a data division unit, data included in one stripe is stored divided into three SSDs, and a parity is stored in another SSD. For example, when the size of data managed by one address HA is 4 KB, the size of data managed by one address SA in a stripe is 12 KB. Mutual conversion can be performed between the address SA and the address HA using the following formula (8).

Address HA=address SA×(N_{CNT}−S_{CNT}) (8)

In the above-mentioned conditions, the following formula (9) can be obtained from formula (8).

Address HA=address SA×3 (9)

Simple description will be made of control of the RAID5.

When the STC 1302 receives data to be written, from the server 0101, the parities are calculated from the data, and the data and the parities are stored in the separate SSDs 0130. For example, the data is stored divided into the SSD numbers 0 to 2, and the parities are stored in the SSD number 4. When the STC 1302 cannot read data from one of the SSD numbers 0 to 2 due to failure or the like of the SSD 0130, for example, when the data cannot be read from the SSD number 0, the STC 1302 reads the data from the SSD numbers 1 and 2 storing the rest of the data, and reads the parities from the SSD number 4. The data stored in the SSD number 0 is restored from these data and parities. Owing to such a configuration, data can be read even if one of the five SSDs constituting the RAID has failure, and the server 0101 can continue to work.

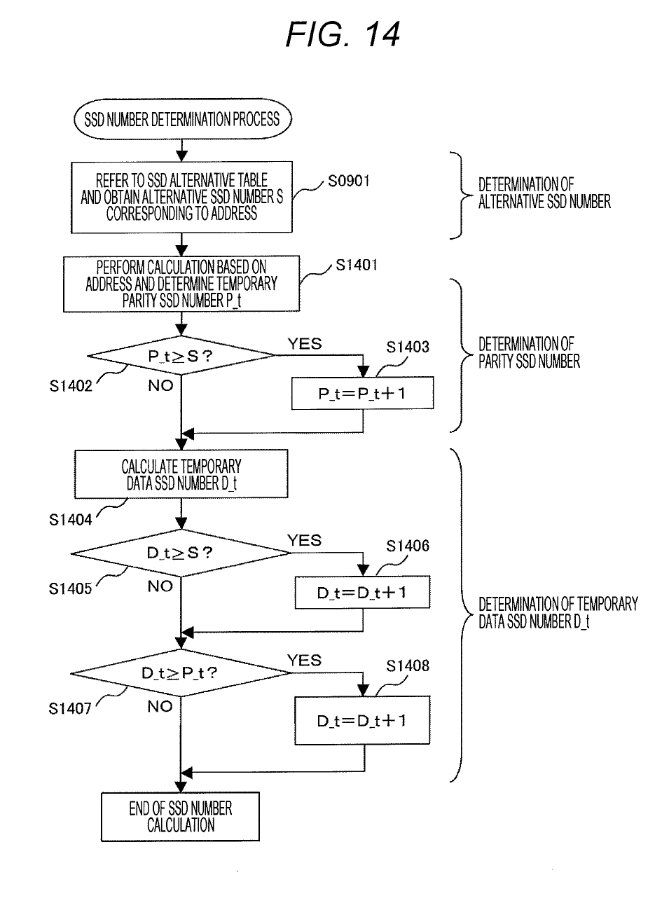

A write process performed by the STC 1302 will be described using FIG. 14. FIG. 14 is a flowchart illustrating an SSD number determination process included in the write process performed by the STC 1302, and of the flowchart, processes denoted by the same reference signs as those used in FIG. 9 have already been described, and description thereof will be omitted. The SSD number determination process includes the alternative SSD number determination process, a parity SSD number determination process, and the determination process of the temporary data SSD number D_t.

First, the alternative SSD number S is obtained (step S0901). Next, a temporary parity number P_t is determined based on the address HA (step S1401). For example, the temporary parity number P_t can be determined using the following formula (10).

P_t=N_{CNT}−S_{CNT}−P_{CNT}−(address HA mod(N_{CNT}−S_{CNT})) (10)

In this example, the following formula (11) can be obtained.

P_t=3−(address HA mod 4) (11)

Further, it is determined whether the temporary parity number P_t is not less than the alternative SSD number S (step S1402). When P_t is not less than S, the temporary parity number P_t is increased by one (step S1403). Next, the temporary data SSD number D_t is calculated (step S1404). For example, the following formula (12) can be used for the calculation.

D_t=address HA mod(N_{CNT}−S_{CNT}−P_{CNT}) (12)

In this example, the following formula (13) is obtained.

D_t=address HA mod 3 (13)

Further, the temporary data SSD number D_t and the alternative SSD number S are compared (step S1405). When D_t is not less than S, D_t is increased by one (step S1406). Next, D_t and the temporary parity number P_t are compared. When D_t is not less than P, D_t is increased by one (step S1408).

Then, it is confirmed whether the SSD 0130 having the temporary data SSD number D_t is under GC. When the SSD 0130 is under GC, a write to another SSD 0130 is performed (alternative write process 1), and an actual parity SSD number P is set to P_t. When the SSD 0130 is not under GC, it is confirmed whether the SSD 0130 having the temporary parity number P_t is under GC. When the SSD 0130 is under GC, an actual parity number P is set to S. That is, instead of writing the parity to the SSD 0130 under GC, the parity is written to the alternative SSD being another SSD 0130 (alternative write process 2). When the SSD 0130 is not under GC, the actual parity number P is set to P_t. And then, it is determined whether the shift process is performed, and if necessary, the shift process is performed.

Control is performed as described above to increase the number of erased blocks in the SSDs 0130 storing the data and the parities, and thus, a write to an SSD 0130 having reduced IOPS performance or low response performance is prevented, and the storage device 1302 having high IOPS performance or high response performance can be achieved.

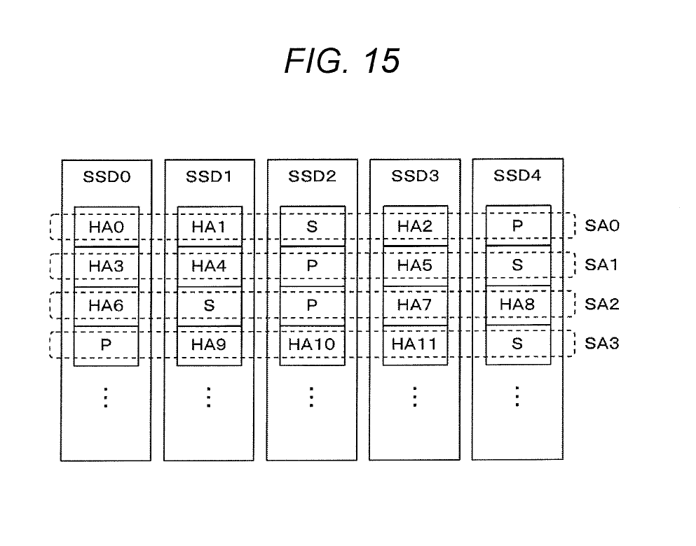

FIG. 15 is a diagram illustrating a relationship between the data corresponding to the addresses HA and the SSDs 0130 storing the data. Three addresses HA, S representing one alternative SSD, and one parity P are allocated to an area indicated by one address SA. The addresses HA are arranged in ascending order with respect to the SSD number, the temporary parity number P_t is controlled to be calculated from the address HA, and only management of the alternative SSD number S is required for each stripe. Thus, the size of data of the alternative SSD table can be reduced. Therefore, the capacity of the RAM 0117 or the like in the STC 1302 can be reduced, and the storage device 1301 can be achieved inexpensively.

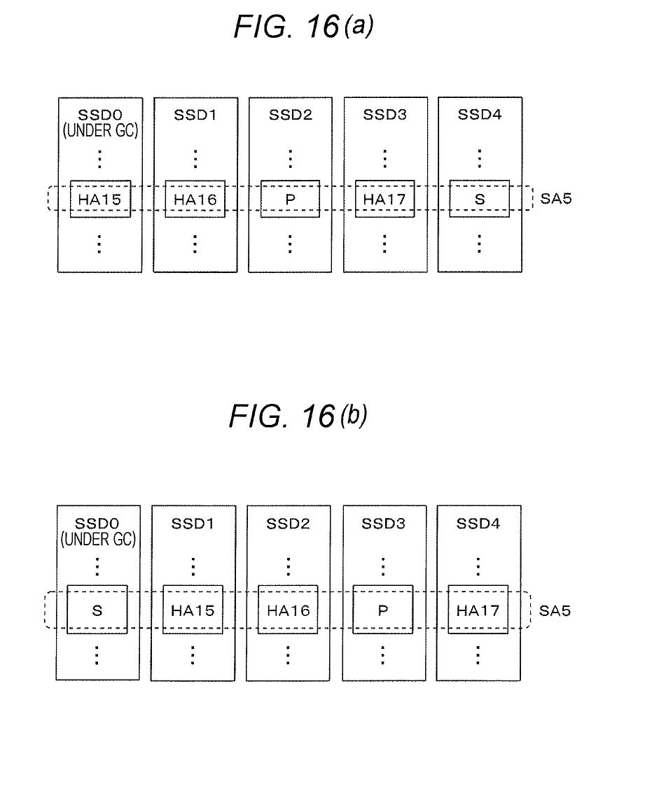

FIGS. 16(a) and 16(b) are diagrams illustrating data arrangements before and after the server 0101 writes data at address HA15 while the data at address HA15 is stored in SSD0 under GC. In address SA5, addresses HA15, HA16, P, and HA17 need to be recorded in ascending order with respect to the SSD numbers, data transmitted from the server 0101 is written to SSD1, the parity is written to SSD3, and data at addresses HA16 and HA17 are written to SSD2 and SSD4 by the shift process. In FIGS. 16(a) and 16(b), the write process is performed on four SSDs 130, that is, SSD1, SSD2, SSD3, and SSD4.

### Fourth Embodiment

In a fourth embodiment, description will be made of an example of the storage device 1301 having higher IOPS performance or higher response performance. The fourth embodiment is different from the third embodiment in information managed by the alternative SSD table of the STC 1302 included in the storage device 1301.

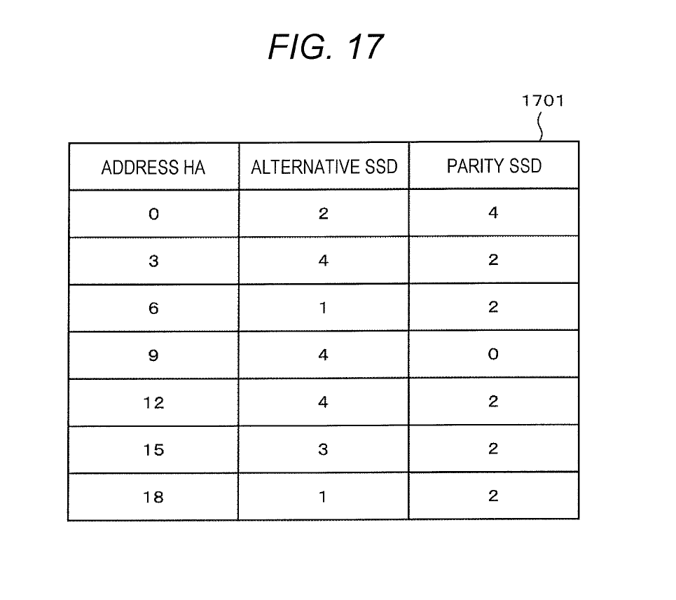

FIG. 17 is a diagram illustrating an example of an alternative SSD table 1701. The alternative SSD table 1701 manages not only the alternative SSD but also the SSD number of the parity SSD. The further management of the number of the parity SSD reduces the probability of requiring the shift process, and further, even if the shift process is generated, the amounts of read data and write data with respect to the SSD can be reduced. Therefore, the storage device 1301 can have increased IOPS performance or increased response performance.

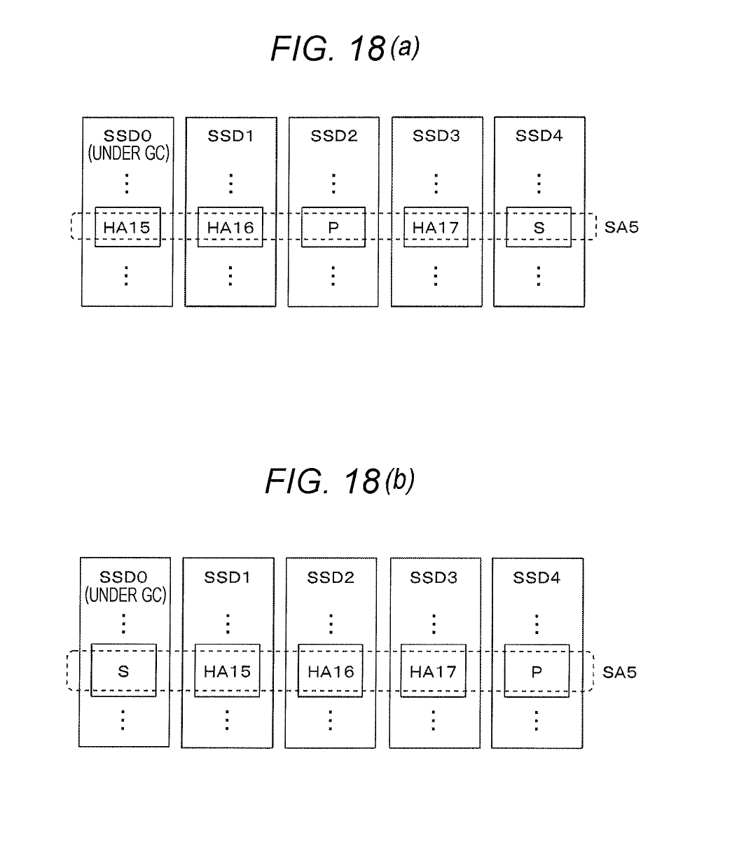

FIGS. 18(a) and 18(b) are diagrams illustrating data arrangements before and after the server 0101 updates data at address HA15 while the data at address HA15 is stored in SSD0 under GC. In the address SA5, the addresses HA15, HA16, and HA17 need to be recorded in ascending order with respect to the SSD numbers. Whereas, the SSD number of the parity SSD can be changed. Thus, data transmitted from the server 0101 is written to SSD1, the parity is written to the SSD4, and data at address HA16 is written to the SSD2 by the shift process. Data of SSD3 does not need to be shifted. In FIGS. 18(a) and 18(b), the write process is performed on three SSDs 130, that is, SSD1, SSD2, and SSD4. The number of SSDs 130 on which the write process is to be performed can be reduced by one, compared with FIGS. 16(a) and 16(b) of the third embodiment.

### Fifth Embodiment

In a fifth embodiment, description will be made of an example of the storage device 1301 having higher IOPS performance or higher response performance than that of the fourth embodiment. The fifth embodiment is different from the fourth embodiment in the information managed by the alternative SSD table of the STC 1302 included in the storage device 1301.

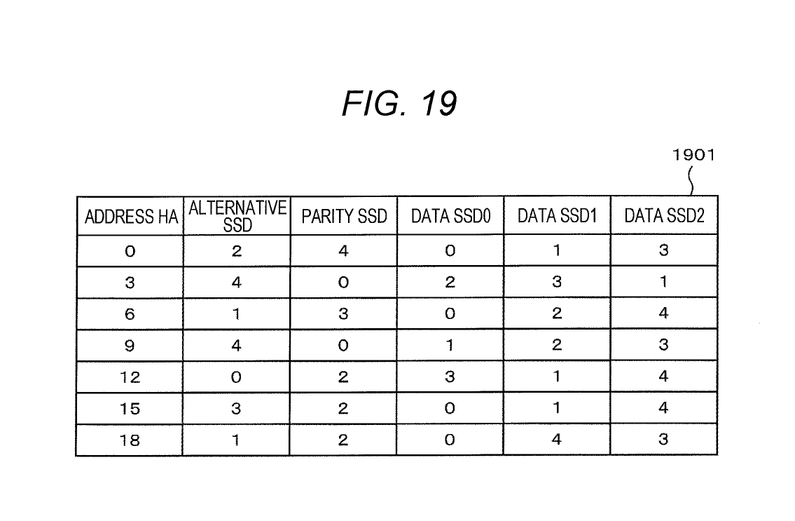

FIG. 19 illustrates an alternative SSD table 1901 corresponding to the RAID. The alternative SSD table 1901 manages the alternative SSD, the parity SSD, and the SSD numbers of the data SSDs. Management of these SSD numbers eliminates the need for the shift process, and the amounts of read data and the write data with respect to the SSD 0130 can be reduced. Thus, the storage device 1301 can have increased IOPS or response performance, and increased reliability.

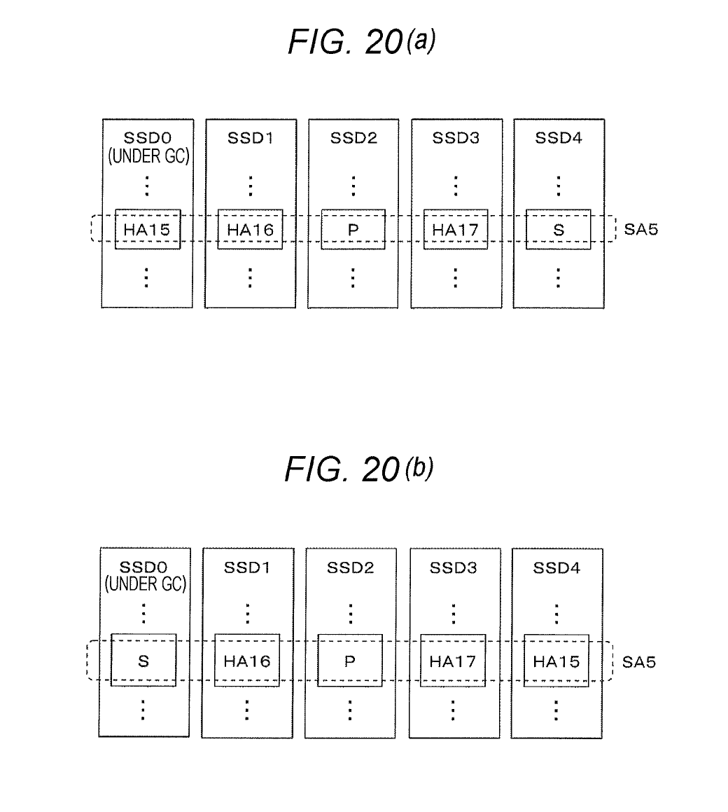

FIGS. 20(a) and 20(b) are diagrams illustrating data arrangements before and after the server 0101 updates data at address HA15 while the data at address HA15 is stored in SSD0 under GC. In the address SA5, the data or parities may be recorded regardless of the SSD numbers. Therefore, only writing of data transmitted from the server 0101 to SSD4 and writing of the parity to SSD2 are required, and the shift process is not required. In FIGS. 20(a) and 20(b), the write process is performed on two SSDs 0130, that is, SSD2, and SSD4. The number of SSDs 0130 on which the write process is to be performed can be reduced by one, compared with FIG. 19 of the fourth embodiment. Note that the parity is updated with data update, and updated parity needs to be written.

### Sixth Embodiment

In a sixth embodiment, description will be made of application of the RAID configuration particularly having high read response performance.

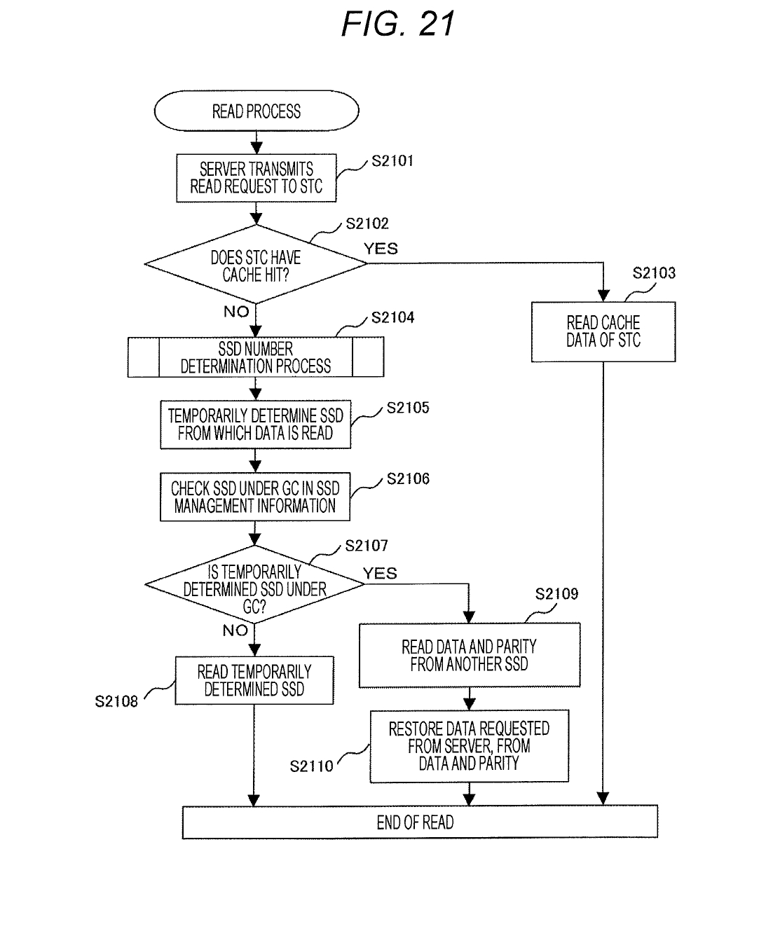

FIG. 21 is a flowchart illustrating the read process.

First, the server 0101 transmits a read request to the STC 1302 (step S2101). Next, the STC 1302 determines whether the RAM 0117 or the like in the STC 1302 has a cache hit (step S2102). The entry number and the tag value are calculated based on the address HA, comparison is made on the tag values of the caches included in the entry number, and a hit can be determined. When there is a cache hit, data is read from the cache, and the data is transmitted to the server 0101 (step S2103). When there is a cache miss, the SSD number determination process is performed (step S2104). Through this process, the STC 1302 determines which SSD 0130 stores data requested from the server 0101 to the STC 1302 (step S2105). The SSD 0130 storing the data is defined as a temporarily determined SSD. Next, the SSD management information control unit 0116 is used to check an SSD number being under GC, from the SSD management information 0501 (step S2106). Further, it is determined whether the number of SSD under GC matches the number of temporarily determined SSD (step S2107). When the numbers do not match, the temporarily determined SSD is not under GC, and the data is read from the temporarily determined SSD (step S2108). When the numbers match, an SSD 0130 storing the data requested from the server 0101 is under GC. At that time, a read is not performed from the SSD 0130 under GC, and other data and another parity are read from another SSD 130. The another SSD 130 is different from the SSD 0130 under GC and included in a stripe including the data requested from the server 0101 (step S2109). The STC 1302 restores the data requested from the server 0101 based on these other data and another parity, and the data is transmitted to the server 0101 (step S2110). Then, the data read from the SSD 0130 can be written to the cache of the STC 1302. Needless to say, when the cache is full, write-back of old data may occur from the cache of the STC 1302 to the SSD 0130.

As described above, a read is performed from an SSD 0130 not under GC, the storage device having high read response performance can be achieved. (Seventh embodiment) In a seventh embodiment, description will be made of an example of the storage devices 0110 and 1301 having high data transfer performance, in particular, high write data transfer performance. Therefore, when concentration of write accesses to one specific SSD 0130 occurs the write accesses are distributed to other SSDs 0130 (write distribution process). Distributed data are managed based on the alternative SSD tables 0201, 1101, 1701, and 1901. Upon reading, the alternative SSD tables 0201, 1101, 1701, and 1901 are used to check the SSDs 0130 storing data and read the data.

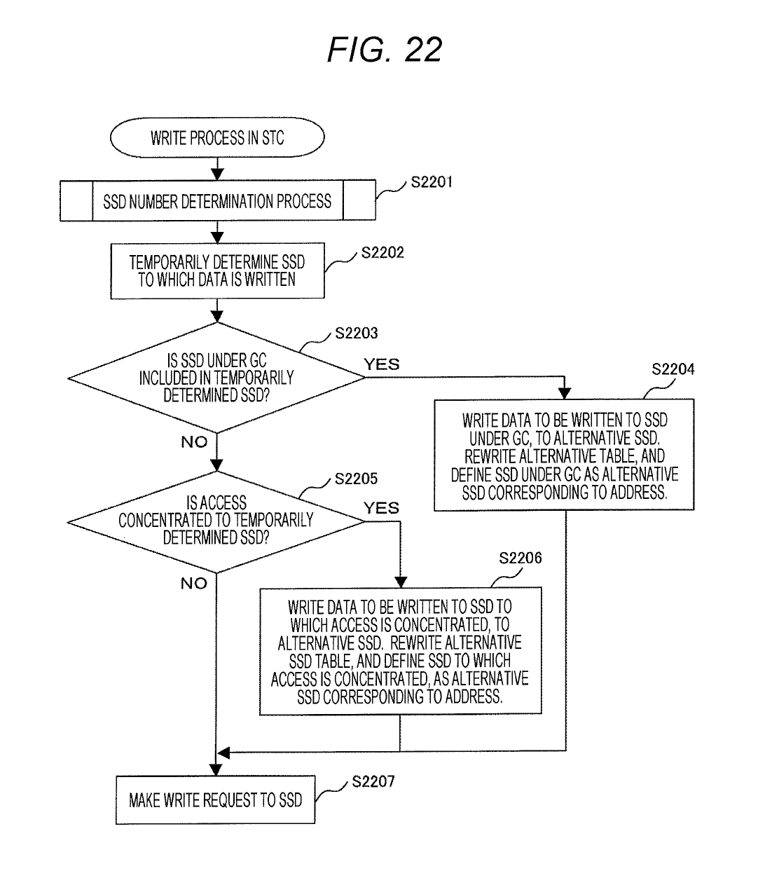

FIG. 22 is an exemplary flowchart illustrating a write process performed by the STCs 0111 and 1302. The SSD number determination process is performed at first (step S2201). Therefore, the STCs 0111 and 1302 can determine the SSD number including data specified by the server 0101, and the alternative SSD number in a stripe including the data (step S2202). Next, it is determined that the SSD 0130 temporarily determined includes the SSD 0130 under GC. Note that writes to a plurality of SSDs 0130 may occur for a single write request from the server 0101. When the SSD 0130 under GC is included, the alternative write process is performed, for example, similar to steps S0907 to S0911 of FIG. 9 (step S2204). When the SSD 0130 under GC is not included, it is determined whether accesses are concentrated to the SSD temporarily determined (step S2205). For determination of concentration, a method can be used which includes obtaining a history of, for example, 1000 accesses to the SSD 0130 in the past, and determining whether the number of accesses to the SSD temporarily determined is a certain percentage larger than an average number of accesses to the SSDs 0130. For example, when the number of accesses is twice larger than the average value, it is considered that the accesses are concentrated. When the accesses are concentrated, data to be written to the SSD 0130 is written to the alternative SSD (write distribution process). At the same time, the alternative SSD tables 0201, 1101, 1701, and 1901 are updated, and the SSD to which the accesses are concentrated is defined as the alternative SSD corresponding to the address HA. The STCs 0111 and 1302 manages the write distribution process performed as described above. When the server reads the storage device, the read process is performed for example using a method illustrated in FIG. 10.

As described above, the write access is prevented from being concentrated on one SSD, and the write accesses can be distributed to a plurality of SSDs 0130 on average. Thus, one SSD 0130 can be prevented from being a bottleneck for the whole of the storage devices 0110 and 1301, and data transfer performance of the storage devices 0110 and 1301 is increased. The storage device particularly having high write data transfer performance can be achieved.

### Eighth Embodiment

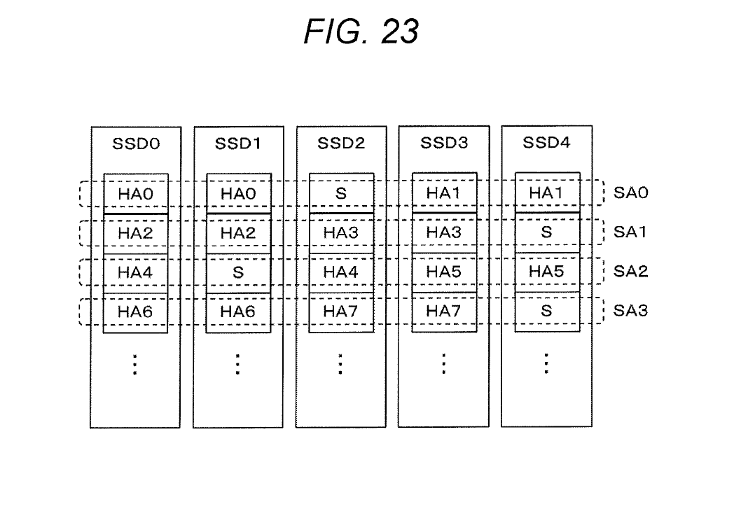

In an eighth embodiment, an example of the storage device having high reliability and high data transfer rate performance will be described based on FIG. 23.

The STC 111 performs mirroring of data transmitted from the server 101, that is, stores the same data in a plurality of SSDs. In FIG. 23, data at address HA0 is stored in SSD0 and SSD1, and data at address HA1 is stored in SSD3 and SSD4. Here, double-mirroring is performed, and one alternative SSDs is employed for description. The number of SSDs in which garbage collection is performed is controlled to be one or less by the STC 111 through the process of FIG. 7, and further the STC 111 performs control so that a write is not performed to the SSD under garbage collection. When the write to the SSD under GC is scheduled, that is, the number of SSD under GC is defined as the temporary data SSD number D_t, the alternative write process is performed to write data to the alternative SSD and update the alternative SSD table information.

Further, when data is scheduled to be read from the SSD under GC for a read request, that is, when the number of SSD under GC is defined as the temporary data SSD number D_t, data is read from another SSD constituting the mirroring, in which garbage collection is not performed.

Since the above-described configuration provides duplicate data, reliability of the storage device can be increased, and further, since generation of the parity or data restoration using the parity is not required, data transfer rate performance of the storage device can be further increased.

### Ninth Embodiment

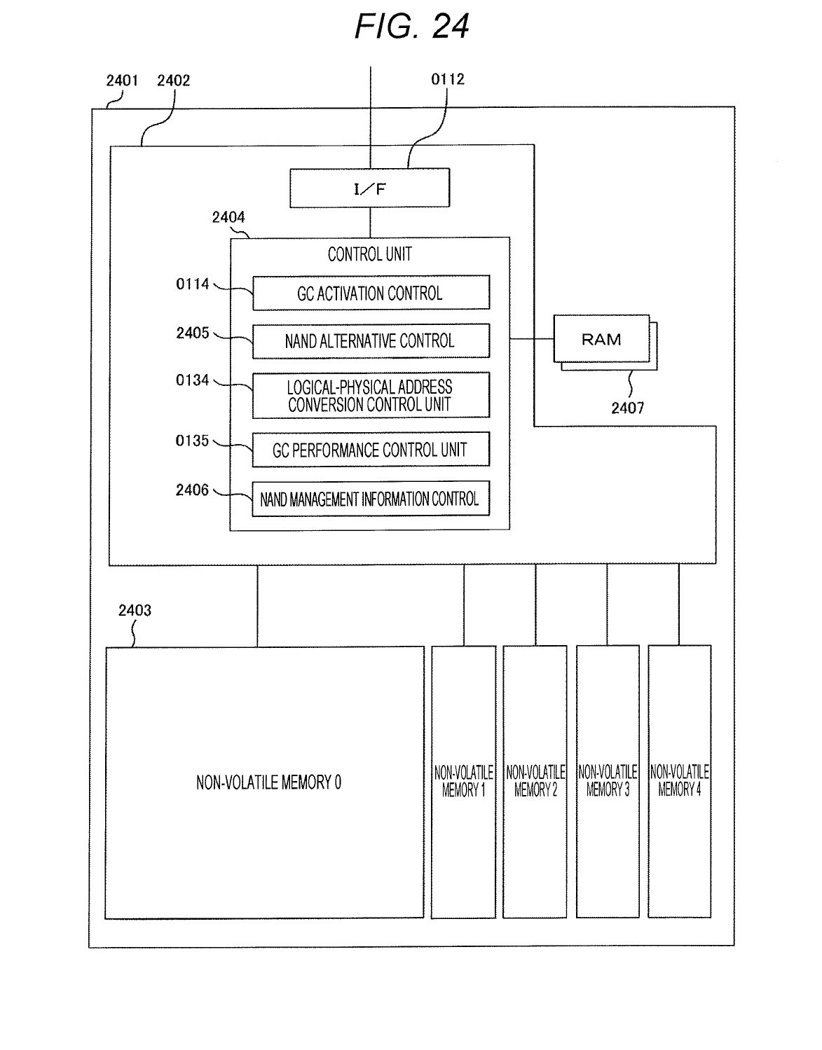

In a ninth embodiment, an example of SSD 241 having high IOPS performance or high response performance, in addition to the storage device 0110, will be described based on FIG. 24.

When an SSD control unit 2404 accesses to one NAND non-volatile memory 2403 in one SSD 2401, for garbage collection, and write access to the NAND non-volatile memory 2403 begins, that is the NAND non-volatile memory 2403 under GC is defined as a temporarily determined NAND number, a NAND alternative control unit 2405 performs alternation, changing the temporarily determined NAND number to another NAND non-volatile memory 2403 not under GC, performing the write access on the NAND non-volatile memory 2403 to which the temporarily determined NAND number is changed, and access to the NAND non-volatile memory 2403 under GC is not performed. A NAND management information control unit 2406 manages the number of erased blocks for each NAND non-volatile memory 2403, and manages the number of the NAND non-volatile memory 2403 in which garbage collection is performed. A RAM 2407 stores all or part of a data buffer, a data cache, an SSD logical address-physical address conversion table, effective/ineffective information for each page, block information such as a state of erased/defective block/programmed block or the number of erasures, information of an alternative non-volatile memory table, and NAND management information. A control chip 2402 includes the server interface 0112 and the control unit 2404. The control unit 2404 includes the GC activation control 0114, but the control unit 2404 may receive a garbage collection instruction through the server interface, and report completion of the garbage collection, and the GC activation control 0114 may manage GC being performed. Although the NAND has been described as an example of the non-volatile memory, a phase-change memory or a ReRAM may be used as another example of the non-volatile memory. In such a case, the phase-change memory or the ReRAM has a higher response performance than that of the NAND, and the SSD having higher response can be achieved.

Owing to the configuration described above, even a single SSD 2401 can perform garbage collection, preventing a write to the NAND non-volatile memory 2403 likely to be busy due to processing from the control unit 2404, and thus, IOPS performance or response performance of the SSD 2401 can be improved.

### Tenth Embodiment

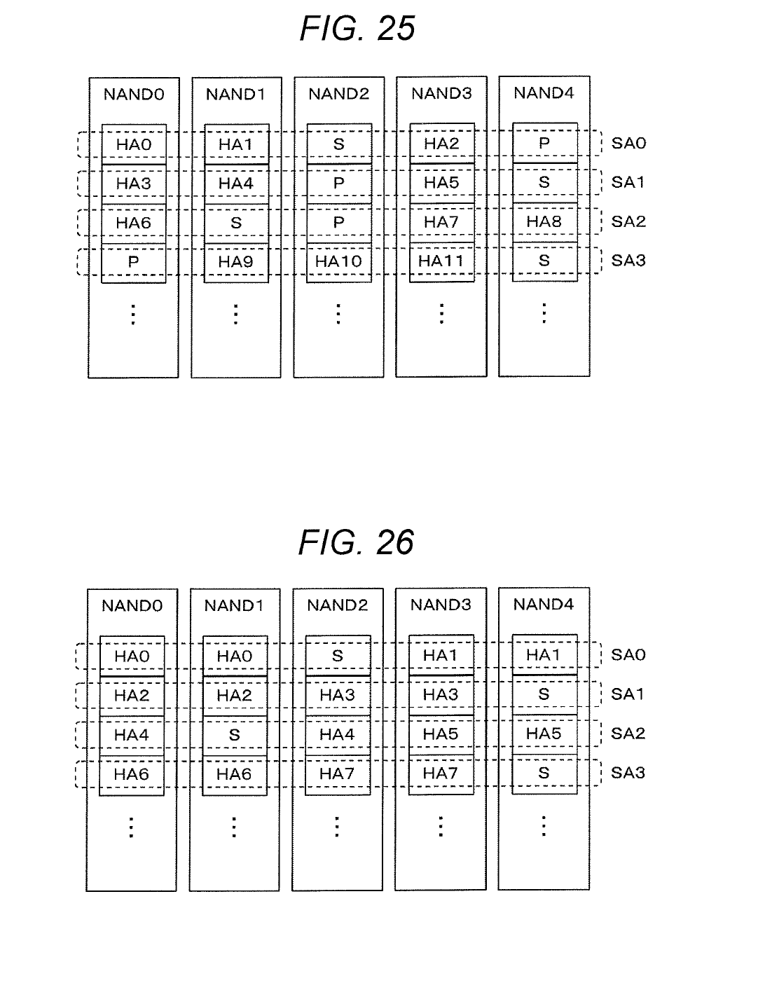

In a tenth embodiment, an example of the SSD 2401 having high IOPS performance or high response performance and high reliability will be described based on FIG. 25.

In the SSD 2401 illustrated in FIG. 24, RAID5 is further controlled to store the data and the parities in the NAND non-volatile memories 2403, such as addresses HA0 to HA2, and P illustrated in FIG. 25. A NAND non-volatile memory 2403 to which a data or a parity are to be written is under GC, that is, a NAND number under GC is defined as the temporarily determined NAND number, the alternative write process is performed to write the data or the parity to the alternative NAND and update alternative NAND table information. Note that, in FIG. 25, the address HA is illustrated, but a physical address may be employed which is obtained by conversion using the SSD logical address-physical address conversion table.

Further, when data is scheduled to be read from the NAND non-volatile memory 2403 under GC for a read request, that is, the NAND number under GC is defined as the temporarily determined NAND number, a data and a parity is read from another NAND non-volatile memory 2403 in which garbage collection is not performed, the data of the NAND non-volatile memory 2403 under GC is restored from the read data and parity, and the restored data is transmitted to a read request source.

Owing to the configuration described above, even a single SSD 2401 can increase the IOPS performance or the response performance, and addition of the parities to the data can increase the reliability.

### Eleventh Embodiment

In an eleventh embodiment, an example of the SSD 2401 having high reliability and high data transfer rate performance will be described based on FIG. 26.

In the SSD illustrated in FIG. 24, the control unit 2404 further performs mirroring of data transmitted from a higher-level device, that is, stores the same data in a plurality of NAND non-volatile memories 2403. In FIG. 26, data at address HA0 is stored in NAND0 and NAND1, and data at address HA1 is stored in NAND3 and NAND4. Here, double-mirroring is performed, and one alternative NAND non-volatile memories 2403 is employed for description. Similar to the mirroring of FIG. 23, the number of NAND non-volatile memories 2403 in which garbage collection is performed is controlled to be one or less by the control unit 2404 controls, and further the control unit 2404 performs control so that a write is not performed to the NAND non-volatile memory 2403 under GC. When a write to the NAND non-volatile memory 2403 under GC is scheduled, that is, the NAND number under GC is defined as the temporarily determined NAND number, the alternative write process is performed to write data to alternative NAND non-volatile memory 2403 and update the alternative NAND table information. Note that, in FIG. 26, the address HA is illustrated, but a physical address may be employed which is obtained by conversion using the SSD logical address-physical address conversion table.

Further, when data is scheduled to be read from a NAND chip under GC for a read request, that is, when the NAND number under GC is determined as the temporarily determined NAND number, data is read from another NAND non-volatile memory 2403 constituting the mirroring, in which garbage collection is not performed.

Since the above-described configuration provides duplicate data, reliability of the single SSD 2401 can be increased, and further, since generation of the parity or data restoration using the parity is not required, data transfer rate performance of the single SSD 2401 can be further increased.

### REFERENCE SIGNS LIST

0100 server-storage system
0101 server
0102 CPU
0103,0117,0132,2407 RAM
0104 storage interface
0105 switch
0110,1301 storage device
0111,1302 storage controller
0112 host interface
0113,1303 control unit
0114 GC activation control
0115 SSD alternative control
0116 SSD management information control
0118,0131,2403 non-volatile memory
0119 SSD interface
0130,2401 SSD
0133 control unit
0134 logical-physical address conversion control unit
0135 GC performance control unit
0136 STC interface
1304 RAID control unit
2405 NAND alternative control
2406 NAND management information control

1. A storage controller controlling a plurality of semiconductor storage devices including at least one first semiconductor storage device storing effective data, and at least one second semiconductor storage device not storing effective data, the storage controller comprising:
a table for management of information identifying the second semiconductor storage device from the plurality of semiconductor storage devices; and
a control unit accessing the first semiconductor storage device or the second semiconductor storage device based on an operation state of the first semiconductor storage device and the table, and dynamically changing the table according to the access.

2. The storage controller according to claim 1, wherein the second semiconductor storage device is used for storing new effective data in the second semiconductor storage device or at least two first semiconductor storage devices other than the first semiconductor storage device, an operation state of the first semiconductor storage device includes an operation state based on a garbage collection instruction to the semiconductor storage device and garbage collection completion notice from the semiconductor storage device, and the storage controller includes the control unit accessing the first semiconductor storage device or the second semiconductor storage device based on an operation state of garbage collection of the first semiconductor storage device and the table.

3. The storage controller according to claim 2, further comprising the control unit accessing the first semiconductor storage device or the second semiconductor storage device based on an operation state of concentrated accesses to the first semiconductor storage device.

4. The storage controller according to claim 3, further comprising the control unit changing access to be made to the first semiconductor storage device having the operation state of garbage collection or the operation state of concentrated accesses, to access to the first semiconductor storage device other than the first semiconductor storage device as an access destination or the second semiconductor storage device, and accessing the first semiconductor storage device or the second semiconductor storage device to which the access destination is changed.

5. The storage controller according to claim 4, further comprising the control unit changing the table to register, as information identifying new second semiconductor storage device, the first semiconductor storage device to which the access is to be made.

6. The storage controller according to claim 4, further comprising the control unit identifying the first semiconductor storage device to which the access is made, by using the information identifying the second semiconductor storage device, and calculating the number of the first semiconductor storage device to which the access is made, or by referring to the number of the first semiconductor storage device to which the access is made, the table also including all numbers of the first semiconductor storage devices.

7. The storage controller according to claim 1, further comprising:
the table further managing information identifying, from the plurality of semiconductor storage devices, a third semiconductor storage device storing a parity; and
a control unit further performing RAID control of a plurality of the first semiconductor storage devices.

8. The storage controller according to claim 7, further comprising a control unit alternating information identifying the second semiconductor storage device, and information identifying the third semiconductor storage device.

9. The storage controller according to claim 7, further comprising the control unit changing read operation from the first semiconductor storage device based on the operation state of the first semiconductor storage device, to data restoration operation of data using data of the first semiconductor storage device and a parity of the third semiconductor storage device, the first and third semiconductor storage devices not being read.

10. The storage controller according to claim 1, further comprising a control unit further performing mirroring control to a plurality of the first semiconductor storage devices.

11. A storage device comprising the storage controller according to claim 1, and the plurality of semiconductor storage devices.

12. A storage system comprising the storage device according to claim 11, and a server for read access and write access to the storage device.

13. A semiconductor storage device comprising:
a plurality of non-volatile memory chips including at least one first non-volatile memory chip storing effective data, and at least one second non-volatile memory chip not storing effective data;
a table managing information identifying the second non-volatile memory chip from the plurality of non-volatile memory chips; and
a control unit accessing the second non-volatile memory chip based on an operation state of the first non-volatile memory chip according to a garbage collection instruction and the table, and dynamically changing the table based on the access.

14. A semiconductor storage device receiving a garbage collection instruction from a storage controller controlling a semiconductor storage device.

15. The semiconductor storage device according to claim 14, wherein the semiconductor storage device reports completion of garbage collection to the storage controller.
